(19) United States
(12) Patent Application Publication
(10) Pub. No.: US 2022/0398417 A1
(43) Pub. Date: Dec. 15, 2022

(54) METHODS AND SYSTEMS FOR MAXIMUM CONSISTENCY BASED OUTLIER HANDLING

(71) Applicant: Samsung Electronics Co., Ltd., Gyeonggi-do (KR)

(72) Inventors: Wentao ZHANG, San Jose, CA (US); Junkun WAN, San Jose, CA (US)

(21) Appl. No.: 17/830,915

(22) Filed: Jun. 2, 2022

Related U.S. Application Data
(60) Provisional application No. 63/210,768, filed on Jun. 15, 2021.

(51) Int. Cl. G06K 9/62

(52) U.S. Cl. CPC G06K 9/6284; G06K 9/6276; G06K 9/6298

(57) ABSTRACT

A method of handling outliers is provided. The method includes determining a set of residuals, wherein each residual represents a difference between a measurement included in a set of measurements and a predetermined estimate; clustering the residuals into a plurality of clusters; calculating a consistency value for each of the plurality of clusters based on a number of measurements included in the set of measurements and a standard deviation of the measurements; identifying a cluster having a maximum consistency value among the plurality of clusters as inliers by applying the consistency function to the plurality of clusters; and handling the outliers based on an approximation of one or more parameters as a function of a statistical relationship of the inliers included in the cluster having the maximum consistency value among the plurality of clusters and an initial estimation of the one or more parameters.

### PRIORITY

This application is based on and claims priority under 35 U.S.C. § 119(e) to U.S. Provisional Patent Application Ser. No. 63/210,768, filed on Jun. 15, 2021, the entire content of which is incorporated herein by reference.

### FIELD

The present disclosure is generally related to improving wireless communication and outlier detection.

### BACKGROUND

In a wireless communication system (e.g., a global navigation satellite system (GNSS)), some environments (such as urban canyons) may present wireless communication challenges. For example, a GNSS may use a plurality of satellites orbiting the earth. The plurality of satellites may form a constellation network of satellites. A GNSS receiver (e.g., a terminal device) may detect a signal.

GNSS signals are often subject to severe blockage, reflection, and attenuation, and the accuracy of a signal may vary and, therefore, locating the GNSS receiver (e.g., for final navigation performance such as geolocation) may be drastically deteriorated. In order to improve the navigation performance under such conditions, deteriorated GNSS signals should be identified and properly accounted for to avoid impacts on, for example, a position estimate (e.g., final navigation performance). If a particular GNSS signal is deteriorated and imprecise, then it may be a considered to be a measurement outlier. A measurement outlier is a piece of data that differs significantly from other pieces of data and lies outside of a statistical distribution. A measurement inlier is a piece of data that lies inside of the statistical distribution.

In addition to GNSS, other satellite systems may be used in wireless communication (e.g., global positioning systems (GPS), Galileo satellite navigation systems, BeiDou satellite navigation systems, etc.), thereby increasing the number of signals and the likelihood that outliers may be present.

Navigation filters may be used to detect outliers. However, capabilities of navigation filters to identify and/or detect outliers are limited by the reliability of estimated parameters in the filters. In addition, if outliers are present but not detected and isolated, parameters may be contaminated, which hinder further outlier detection.

The efficiency of traditional outlier detection methodologies is highly dependent on a measurement uncertainty model to accurately model actual errors in measurements that have already occurred. The efficiency of the traditional outlier detection methodology is also highly dependent on there being very few outliers as compared to a total number of measurements.

However, in some wireless communication environments, the number of outliers may not necessarily be much fewer than the total number of measurements, and the accuracy of outlier detection may be negatively impacted.

Thus, in order to improve positioning accuracy in a wireless environment, for example, a solution is needed to efficiently identify outliers without relying on accurately identifying actual errors in measurements and/or there being very few outliers relative to the total number of measurements.

### SUMMARY

The present disclosure has been made to address the above-mentioned problems and disadvantages, and to provide at least the advantages described below.

In accordance with an aspect of the present disclosure, a method of handling outliers is provided. The method includes determining a set of residuals, wherein each residual represents a difference between a measurement included in a set of measurements and a predetermined estimate; clustering the residuals into a plurality of clusters; calculating a consistency value for each of the plurality of clusters based on a number of measurements included in the set of measurements and a standard deviation of the measurements; identifying a cluster having a maximum consistency value among the plurality of clusters as inliers by applying the consistency function to the plurality of clusters; and handling the outliers based on an approximation of one or more parameters as a function of a statistical relationship of the inliers included in the cluster having the maximum consistency value among the plurality of clusters and an initial estimation of the one or more parameters.

In accordance with another aspect of the present disclosure, an electronic device including a processor and a non-transitory computer-readable storage medium are provided. The non-transitory computer-readable storage medium stores instructions that, when executed, cause the processor to determine a set of residuals, wherein each residual represents a difference between a measurement included in a set of measurements and a predetermined estimate; cluster the residuals into a plurality of clusters; calculate a consistency value for each of the plurality of clusters based on a number of measurements included in the set of measurements and a standard deviation of the measurements; identify a cluster having a maximum consistency value among the plurality of clusters as inliers by applying the consistency function to the plurality of clusters; and handle outliers based on an approximation of one or more parameters as a function of a statistical relationship of the inliers included the cluster having the maximum consistency value among the plurality of clusters and an initial estimation of the one or more parameters.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates an electronic device in a network environment, according to an embodiment;

FIG. 2A illustrates approximate residual values for a number of measurements (ith Meas) for a given parameter set, according to an embodiment;

FIG. 2B illustrates the approximate residual values for the given parameter set for the ith Meas of FIG. 2A sorted in ascending order, according to an embodiment;

FIG. 2C illustrates the sorted approximate residual values for the given parameter set for parameter the ith Meas of FIG. 2B separated into clusters, according to an embodiment;

FIG. 2D illustrates the clustered residual values for the given parameter set for the ith Meas of FIG. 2C with a consistency value (cv) assigned to each cluster, according to an embodiment;

FIG. 2E illustrates identifying a local maximum consistency value (mcv) for the cv-assigned clustered residual values for the given parameter set for the ith Meas of FIG. 2D, according to an embodiment;

FIG. 3 illustrates a method for searching for inliers based on a local mcv and a global mcv, according to an embodiment; and

FIG. 4 illustrates a method for integrating maximum consistency based outlier handling (McBoH) to general estimation processing, according to an embodiment.

### DETAILED DESCRIPTION

Hereinafter, embodiments of the present disclosure are described in detail with reference to the accompanying drawings. The same or similar elements may be designated by the same reference numerals although they are shown in different drawings.

In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure.

In addition, descriptions of well-known functions and constructions are omitted for clarity and conciseness.

The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

An electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Terms such as “1st,” “2nd,” “first,” and “second” may be used to distinguish a corresponding component from another component, but are not intended to limit the components in other aspects (e.g., importance or order). If an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

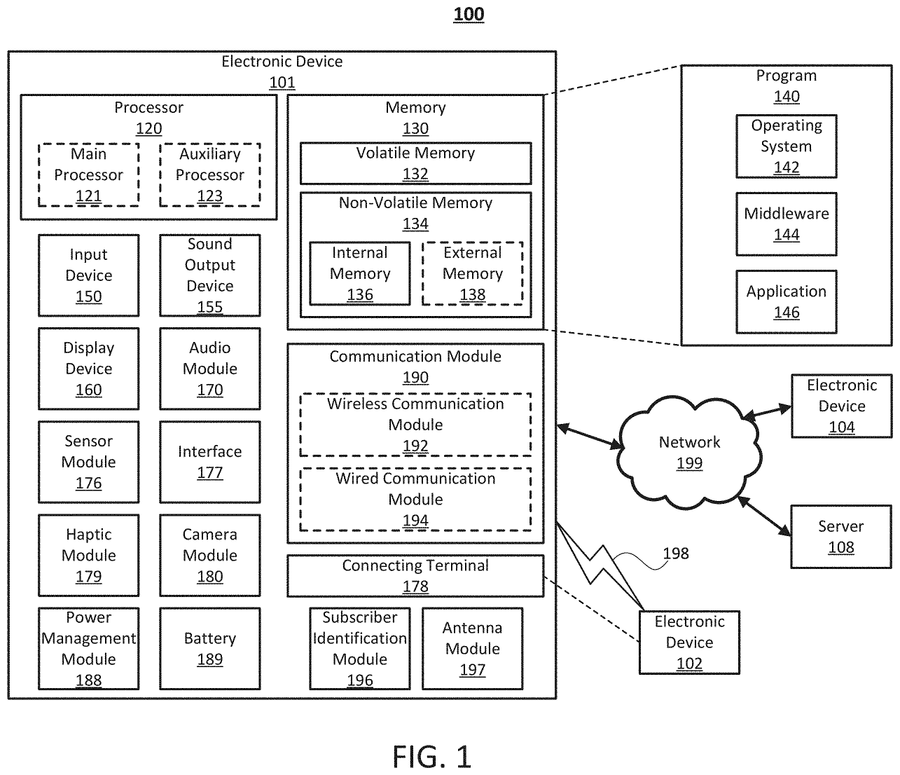

FIG. 1 illustrates an electronic device in a network environment, according to an embodiment.

Referring to FIG. 1, the electronic device 101, e.g., a mobile terminal including GPS functionality, in the network environment 100 may communicate with an electronic device 102 via a first network 198 (e.g., a short-range wireless communication network), or an electronic device 104 or a server 108 via a second network 199 (e.g., a long-range wireless communication network). The electronic device 101 may communicate with the electronic device 104 via the server 108. The electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197 including a GNSS antenna. In one embodiment, at least one (e.g., the display device 160 or the camera module 180) of the components may be omitted from the electronic device 101, or one or more other components may be added to the electronic device 101. In one embodiment, some of the components may be implemented as a single integrated circuit (IC). For example, the sensor module 176 (e.g., a fingerprint sensor, an iris sensor, or an illuminance sensor) may be embedded in the display device 160 (e.g., a display).

The processor 120 may execute, for example, software (e.g., a program 140) to control at least one other component (e.g., a hardware or a software component) of the electronic device 101 coupled with the processor 120, and may perform various data processing or computations. As at least part of the data processing or computations, the processor 120 may load a command or data received from another component (e.g., the sensor module 176 or the communication module 190) in volatile memory 132, process the command or the data stored in the volatile memory 132, and store resulting data in non-volatile memory 134. The processor 120 may include a main processor 121 (e.g., a central processing unit (CPU) or an application processor, and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or execute a particular function. The auxiliary processor 123 may be implemented as being separate from, or a part of, the main processor 121.

The auxiliary processor 123 may control at least some of the functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to one embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to one embodiment, the audio module 170 may obtain the sound via the input device 150, or output the sound via the sound output device 155 or a headphone of an external electronic device 102 directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device 102 directly (e.g., wiredly) or wirelessly. According to one embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device 102. According to one embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via tactile sensation or kinesthetic sensation. According to one embodiment, the haptic module 179 may include, for example, a motor, a piezoelectric element, or an electrical stimulator.

The camera module 180 may capture a still image or moving images. According to one embodiment, the camera module 180 may include one or more lenses, image sensors, image signal processors, or flashes.

The power management module 188 may manage power supplied to the electronic device 101. The power management module 188 may be implemented as at least part of, for example, a power management integrated circuit (PMIC).

The battery 189 may supply power to at least one component of the electronic device 101. According to one embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor) and supports a direct (e.g., wired) communication or a wireless communication. According to one embodiment, the communication module 190 may include a wireless communication module 192 (e.g., a cellular communication module, a short-range wireless communication module, or a GNSS communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or a standard of the Infrared Data Association (IrDA)) or the second network 199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to one embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

One embodiment may be implemented as software (e.g., the program 140) including one or more instructions that are stored in a storage medium (e.g., internal memory 136 or external memory 138) that is readable by a machine (e.g., the electronic device 101). For example, a processor of the electronic device 101 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

The present disclosure describes a device, system, and method that is able to maintain a high degree of accuracy for systems having a larger number of outliers than other models (e.g., a measurement uncertainty model). This may be accomplished identifying and modeling good (reliable) measurements (e.g., inliers) instead of merely excluding bad (unreliable) measurements (e.g., outliers).

In addition, the present disclosure describes clustering of residual sets of data for different candidate parameter sets, where the candidate parameter sets are selected from a search space that is determined by a preliminary estimation of the parameters. A residual may be defined as the difference between an observed value and a predicted mean value for that quantity.

A consistency of the data set may be considered for each candidate parameter set. Consistency of data may describe how widely the data is distributed. For example, data with a narrower distribution may be regarded as more self-consistent. A standard deviation (σ) is a common measure of the consistency of data. The consistency of data in a finite size set of data may be accurately determined based on σ and a data size (n).

A consistency value (cv) is a value that may be determined as a function of a data size n (e.g., the number of data items in a data set) and σ of the data. For example, a larger cv value may indicate better consistency among datasets than a smaller cv value. That is, given the same n (e.g., for a dataset of a fixed size), the dataset with a smaller σ may have a larger cv. In addition, given the same σ, a dataset with a larger n may have a larger cv.

A consistency function ƒ_{c}, as the function of (n, σ), may be represented by Equation 1, below.

cv=ƒ_{c}(n,σ) Equation 1

Each candidate parameter set may correspond to a set of pre-fit residuals, which are clustered into small groups. The group with a largest cv among the groups is referred to as the group with the local maximum consistency value (mcv).

A plurality of candidate parameter sets may include multiple local mcv's, where the maximum value among the local mcv's (e.g., the local mcv having the highest cv) is referred as the global mcv.

A group of measurements corresponding to the global mcv may be taken as the desired set of inliers.

Therefore, the present disclosure does not necessarily assume that a dominant majority of measurements are inliers. Instead, the present disclosure may rely on the number of inliers being greater than the number of parameters in order to ensure that there is a sufficient degree of freedom, thereby allowing the model to be able to account for a large number of outliers.

In addition, the present disclosure may provide a cv of a dataset and a consistency function to calculate such a cv.

Additionally, the present disclosure may provide local and global mcv's, and corresponding definitions.

Accordingly, a relationship between a set of measurement inliers and a global mcv of corresponding residuals, criteria to search for inliers, and reasoning behind the criteria are described below. In addition, a parameter search space is defined, and step-sizes for implementation optimization are defined to obtain local mcv's and determine one or more global mcv's.

Maximum consistency based outlier handling (McBoH) may refer to a method and electronic device capable of performing the method that minimizes effects that outliers (e.g., bad values) may have on approximating (e.g., estimating) parameters by identifying inliers (e.g., good values) for approximating the parameters based a consistency of measurements, as described below.

To estimate m parameters (e.g., x, y, and z coordinate parameters) with n measurements (e.g., a measurement of the x, y, and z coordinate parameters via a first satellite, a measurement of the x, y, and z coordinate parameters via a second satellite, a measurement of the x, y, and z coordinate parameters via a third satellite, etc.) (where n is larger than m) including ≥m inliers and a certain number of outliers, if a reasonably good approximation of the parameters is available, pre-fit residuals may be placed into different clusters, and one cluster that provides the maximum consistency (via an mcv) may be determined to include most of the inliers. Accordingly, the present disclosure introduces a method of identifying inliers by using the mcv.

A residual function l may be used to generate pre-fit residuals for the measurement vector Z (where Z ∈{\tilde{z}, ž}; \tilde{z} is a vector for a good measurement (inlier); and ž is a vector for a bad measurement (outlier)) and a given parameter vector x according to Equation 2, below.

l=ƒᵣ(Z,x) Equation 2

Given Z, each parameter vector x may correspond to a unique set of residuals, and l may then be used to evaluate the cv of each subset (cluster). The maximum cv may be referred to as the mcv of this particular residual set, which is further referred as a “local” mcv, with respect to this particular residual set.

Given the same Z, multiple x vectors may correspond to multiple residual sets. The maximum mcv of all the residual sets may be referred to as a “global” mcv. The global mcv may have the highest cv among the local mcv's. In addition, the residual subset corresponding to the global mcv may include the desired inliers.

According to the present disclosure, for a given parameter vector x, a subset of measurement {\tilde{z}, ž} may be identified which maximizes mcv using Equation 3, below.

$$mcv = arg {max}_{n ∼ [ m + 1 , N ]} {f}_{c} ( n , σ \vert x , \{ \tilde{z} , \breve{z} \} ) \qquad Equation 3$$

where mcv is the mcv of the selected measurement subset with the given x; m is the number of parameters; N is the total number of measurements; [n, σ] is the consistency pair; ƒ_{c}(n, σ) is the consistency function; l is the residual from the residual function l=ƒᵣ (z, x); z is the selected subset of measurement z ∈{\tilde{z}, ž}; and x is the given parameter.

Thus, the consistency function ƒ_{c} may be introduced and defined according to Equation 4, below.

$${f}_{c} ( n , σ ) = \frac{n - 1}{m} \cdot {e}^{1 - \frac{σ}{{σ}_{T}}} \qquad Equation 4$$

where n is the number of items in the given vector l; σ=std(l) is the standard deviation of the given vector l; and m is the number of parameters.

In addition, an mcv for a selected measurement may be defined according to Equation 5, below.

[mcv,idx]=local_mcƒ(Z,x,ƒᵣ,σ_{T}) Equation 5

where Z is a measurement vector (including both \tilde{z} and ž); x is a parameter vector (given); mcv is the mcv of a selected measurement subset for the given x; and idx is indices of the selected measurement (a subset of Z).

As stated above, a residual may be defined as the difference between an observed value and a predicted mean value for the quantity. Therefore, the residual vector l, may be made up of a plurality of values representing differences between observed values and a predicted mean for the quantity. The residuals in the residual vector l may be calculated based on Equation 2, above, and clustered based on a number of different approaches. For example, residuals may be clustered by sorting the residuals, separating the residuals into different clusters using one or more thresholds, calculating ƒ_{c}(n, σ) for each cluster, selecting the cluster with an mcv, and/or outputting the mcv and a corresponding idx.

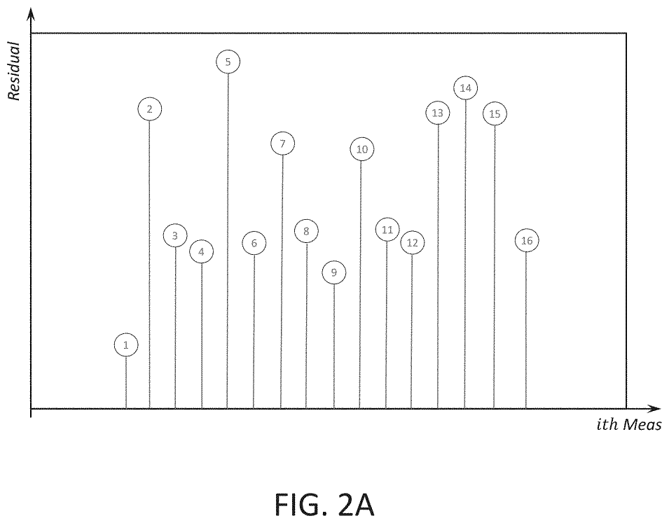

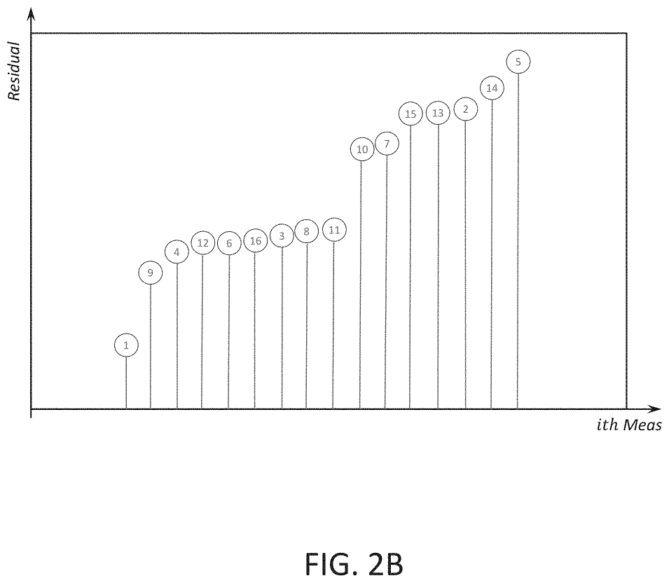

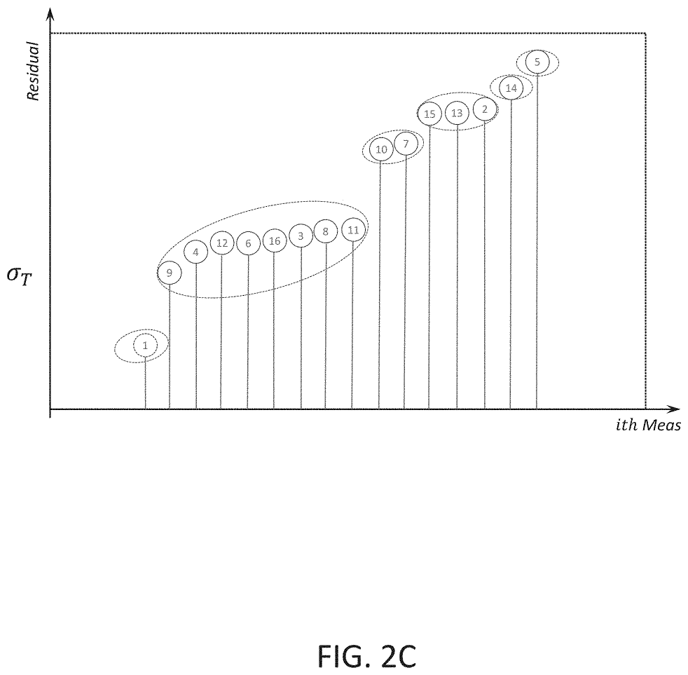

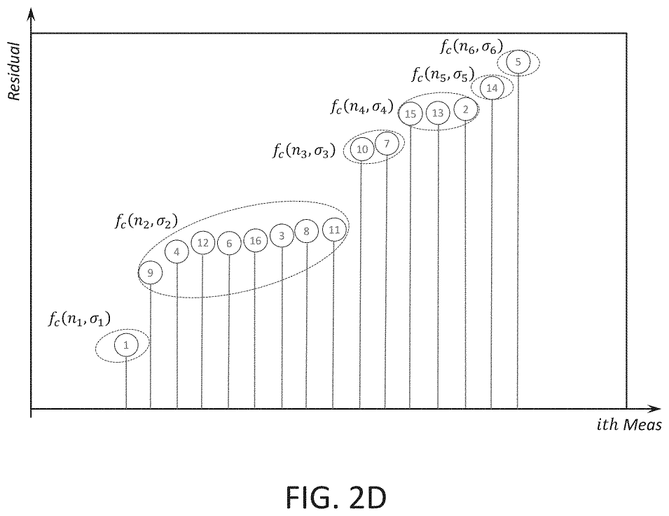

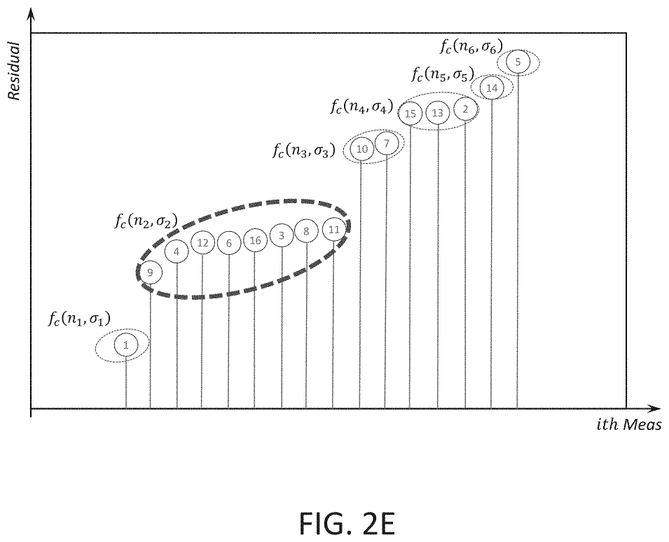

FIG. 2A illustrates approximate residual values for an ith Meas for a given parameter set, according to an embodiment. An ith Meas refers to a measurement of a parameter by an ith device. For example, a first ith Meas may be a pseudo-range of a terminal device by a first satellite, a second ith Meas may be a pseudo-range of the terminal device by a second satellite, a third ith Meas may be a pseudo-range of the terminal device by a third satellite, etc. Therefore, numbers 1-16, shown in FIGS. 2A-2E may refer to respective ith devices. In addition, a device may include electronic device, a terminal, a cellular communication device, a portable computer, a satellite, or any other device capable of sending and/or receiving data. Additionally, the parameter that is measured is not limited to a geolocation and may include timing/synchronization information, physical/spatial information, and/or other types of data.

FIG. 2B illustrates the approximate residual values for the given parameter set for the ith Meas of FIG. 2A sorted in ascending order, according to an embodiment.

Referring to FIG. 2B, the ith Meas residual values of the given parameter are sorted in ascending order.

FIG. 2C illustrates the sorted approximate residual values for the given parameter set for the ith Meas of FIG. 2B separated into clusters, according to an embodiment.

Referring to FIG. 2C, the sorted ith Meas residual values of the given parameter are grouped into different clusters. The clusters are indicated using dotted oval lines in FIG. 2C. The clusters may be grouped according to a given standard deviation (σ_{T}). In addition, each cluster may include a similar or different number of ith Meas residual values.

FIG. 2D illustrates the clustered residual values for the given parameter set for the ith Meas of FIG. 2C with a cv assigned to (or calculated for) each cluster, according to an embodiment. Here, each cv is determined based on the consistency function described above in Equation 1. For example, the cv of a first cluster is ƒ_{c}(n₁, σ₁), the cv of a second cluster is ƒ_{c}(n₂, σ₂), the cv of a third cluster is ƒ_{c}(n₃, σ₃), etc. Mcv's that are calculated for clusters for one parameter x (or a limited number of parameters x) may be referred to as local mcv's.

FIG. 2E illustrates identifying a local mcv for the cv-assigned clustered residual values for the given parameter set for the ith Meas of FIG. 2D, according to an embodiment. A cluster having the highest local mcv among the clusters may be identified as the global mcv, which may then be used for estimating different parameters. As shown in FIG. 2E, ƒ_{c}(n₂, σ₂) is determined to have the highest cv and is therefore determined to be the global mcv.

According to an embodiment, a subset of measurement {\tilde{z}, ž} that maximizes the identified global mcv with the parameter x residing in the range of \check{x}±3σ_{\check{x}} may be provided by Equations 6-7, below.

$$local mcv ( s ) = {arg max}_{n ∼ [ m + 1 , N ]} {f}_{c} ( n , σ \vert x , \{ \tilde{z} , \breve{z} \} ) \qquad Equation 6$$

$$gmcv = {arg max}_{X ∼ [ \breve{X} \pm 3 σ \breve{x} ]} \{ local mcv ( s ) \} \qquad Equation 7$$

where gmcv is a global mcv; \check{x} is an initial estimation of a parameter vector (could be biased); and σ_{\check{x}} is a standard deviation of \check{x}, scaled by predetermined factor (such as 3) to define the search space.

Approximating a parameter vector \tilde{x} may be significantly improved by using the global mcv. For example, a global mcf(global_mcf) may be provided based on Equation 8, below.

[mcv,idx,\tilde{x}]=global_mcf(Z,\check{x},ƒᵣ,σ_{T},σₖ,Δx) Equation 8

where Z is a measurement vector (full set); \check{x} is an initial estimation of a parameter vector (potentially biased); a is a standard deviation of \check{x}; Δx is a stepsize of \check{x} for searching; mcv is a global mcv; idx is indices of the selected measurement; and X is the corresponding parameter vector, with a significant improvement in the approximation (compared to the initial estimation \check{x}).

According to an embodiment, to approximate \check{x}, a search space for x (e.g., a range of parameter x) may be selected. For the selected search space, all candidates of the parameter x may be looped through (e.g., included) for a Δx stepsize (e.g., for a search space of [\check{x}−3σₓ, \check{x}+3σ_{\check{x}}]).

For each candidate parameter x, the local mcv may be calculated by calling Equation 5, above. Accordingly, the candidate parameter x may be appended to a {mcv, idx, x} candidate list fork number of candidates (e.g., {mcv, idx, x}₁, {mcv, idx, x}₂, . . . {mcv, idx, x}ₖ).

The maximum mcv may be searched for among the candidates in the candidate list, and the corresponding idx and x may be output together as {mcv, idx, \tilde{x}}.

As mentioned above, a search space may be selected. For example, the search space may be \check{x}±3·σ_{\check{x}}, where \check{x}, σ_{\check{x}} are from a preliminary solution. The search space may be defined in terms of σ_{\check{x}} scaled by a factor, such as 3.

According to an embodiment, multiple stepsizes may be identified and searched to maximize the global mcv. For example, for a first iteration of stepsize searching, a coarse stepsize may be used. The coarse stepsize may be identified based on Equation 9, below.

$$Δ x = max ( {σ}_{T} / \frac{\partial f ( z , x )}{\partial x} , \frac{{σ}_{\breve{x}}}{2} ) \qquad Equation 9$$

Then, for a second iteration of stepsize searching, a fine stepsize may be used. The fine stepsize may be identified based on Equation 10, below.

$$Δ x = {σ}_{T} / \frac{\partial f ( z , x )}{\partial x} \qquad Equation 10$$

Using both a coarse stepsize and a fine stepsize optimizes identifying the maximum global mcv because ranges of parameter x with different granularities and properties may be considered.

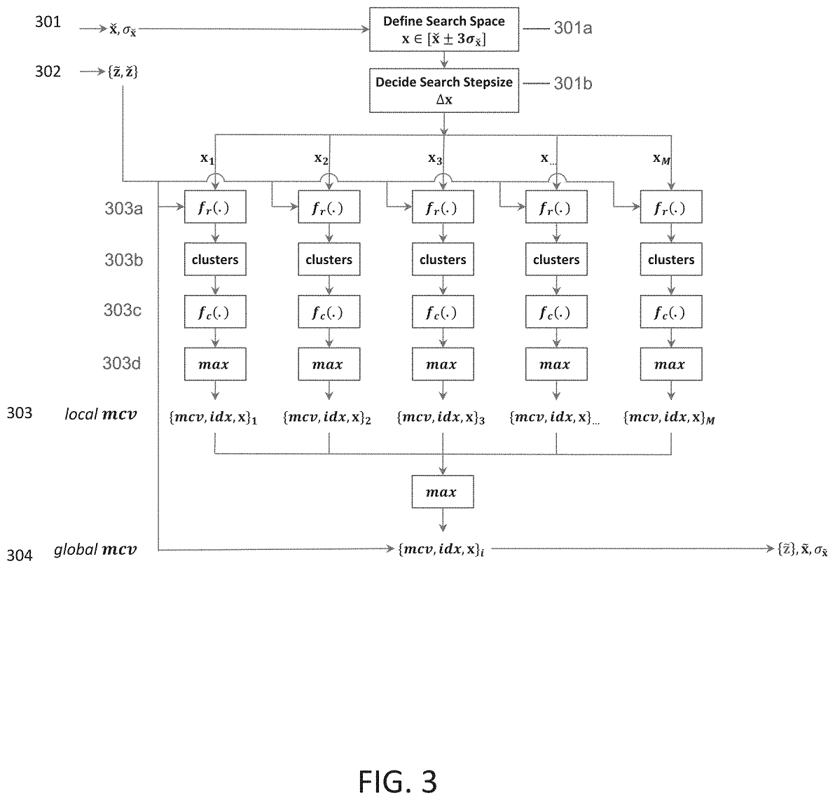

FIG. 3 illustrates a method for searching for inliers based on a local mcv and a global mcv, according to an embodiment.

Referring to FIG. 3, reference numerals 301, 302, 303, and 304 refer to different data sets in the method shown in FIG. 3. The particular data sets that are identified by the reference numerals are identified for convenience of description and should not include or exclude other data sets from the method. As shown in FIG. 3, at 301, an initial parameter (\check{x}) and its standard deviation (σ_{\check{x}}) are provided and used to define a search space (e.g., x∈[\check{x}±3σ_{\check{x}}]) at step 301a. In addition, a search stepsize Δx is determined at step 301b.

Also, measurement {\tilde{z}, \check{x}} 302 is provided and used to determine the local mcv 303 and the global mcv 304. As explained above, different search stepsizes Δx may be used when determining the local mcv 303. For example, a coarse stepsize may be used during a first round of searching, and a fine stepsize may be used during a second round of searching. Additional stepsizes may be used to identify different clusters and/or local mcv's.

As illustrated in FIG. 3, M total stepsizes (x₁ . . . x_{M}) are used to determine the local mcv 303. For example, in step 303a, a residual function ƒᵣ is used to generate the pre-fit residuals for a measurement z and a given parameter vector x₁. In step 303b, the clusters are identified based on the residual function ƒᵣ. In step 303c, ƒ_{c} is calculated for each cluster, and max mcv is output in step 303d. Accordingly, for each stepsize, a max mcv, a corresponding idx, and a parameter x are output for each cluster to obtain the local mcv 303.

A global mcv 304 is then determined based on the maximum mcv 303 (e.g., by comparing which local mcv is includes the largest cv). Then, a \tilde{z} value that maximizes the global mcv with the parameter x residing in the search space (e.g., \check{x}±3σ_{\check{x}}), is determined.

Accordingly, based on the above-described method of clustering data sets for various stepsizes to determine local mcv's, as well as a global mcv, outlier detection can be dramatically improved.

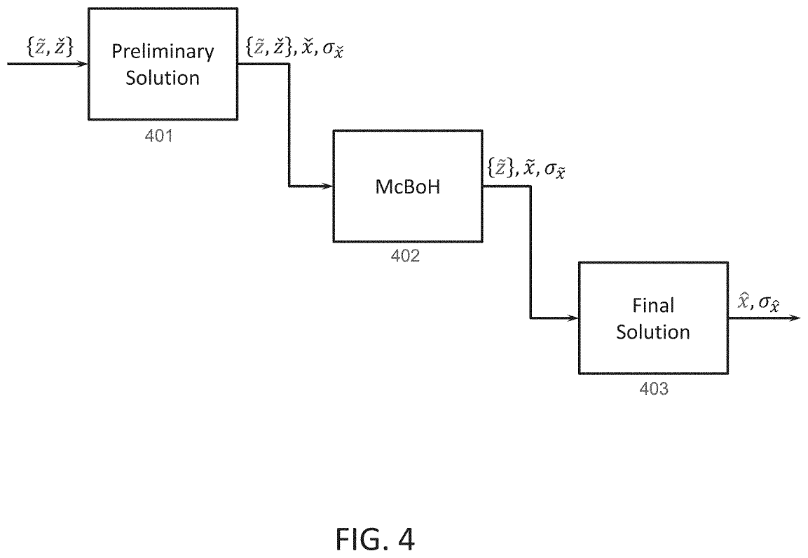

FIG. 4 illustrates a method for integrating McBoH to general estimation processing, according to an embodiment;

Referring to FIG. 4, three steps are shown: a preliminary estimation in step 401, a McBoH in step 402, and a final estimation in step 403.

For example, in step 401, a parameter \check{x} may be estimated based on a subset of measurements {\tilde{z}, ž} with a standard deviation of σ_{\check{x}}. However, in some cases (e.g., if the measurement ž is a bad or unreliable measurement) the parameter \check{x} may be contaminated. Therefore, in step 402, McBoH is applied to identify good or reliable measurements (e.g., using \tilde{z} that maximizes the global mcv). In step 403, parameter \hat{x} is calculated based on the output of McBoH in step 402 by excluding unreliable measurements and is therefore more precise.

As described above, the present application provides a measurement approximation system that does not depend on a measurement uncertainty model and can account for a large number of outliers (e.g., as long as the number of inliers is more than the number of parameters), thereby improving the accuracy of measurement detection.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

1. A method of handling outliers, the method comprising:
determining a set of residuals, wherein each residual represents a difference between a measurement included in a set of measurements and a predetermined estimate;
clustering the residuals into a plurality of clusters;
calculating a consistency value for each of the plurality of clusters based on a number of measurements included in the set of measurements and a standard deviation of the measurements;
identifying a cluster having a maximum consistency value among the plurality of clusters as inliers by applying the consistency function to the plurality of clusters; and
handling the outliers based on an approximation of one or more parameters as a function of a statistical relationship of the inliers included in the cluster having the maximum consistency value among the plurality of clusters and an initial estimation of the one or more parameters.

2. The method of handling outliers of claim 1, further comprising selecting a search stepsize,
wherein clustering the residuals into the plurality of clusters comprises:
clustering a first set of residuals into a first set of the plurality of clusters based on a first stepsize of the search stepsize; and
clustering a second set of residuals into a second set of the plurality of clusters based on a second stepsize of the search stepsize.

3. The method of handling outliers of claim 2, wherein identifying the cluster having the maximum consistency value among the plurality of clusters further comprises:
identifying a first cluster included in the first set of the plurality of clusters as having a first local maximum consistency value;
identifying a second cluster included in the second set of the plurality of clusters as having a second local maximum consistency value; and
determining the maximum consistency value to be a greater value among the first local maximum consistency value and the second local maximum consistency value.

4. The method of handling outliers of claim 3, wherein the approximation of the one or more parameters is based on the statistical relationship of the inliers of the cluster having the global maximum consistency value.

5. The method of handling outliers of claim 2, wherein the first stepsize is a different stepsize than the second stepsize.

6. The method of handling outliers of claim 1, wherein the approximation of the one or more parameters includes an approximation of a set of parameters using the statistical relationship of the inliers included in the cluster having the largest consistency value.

7. The method of handling outliers of claim 1, further comprising:
defining a search space of input parameters based on an initial parameter and its standard deviation.

8. The method of handling outliers of claim 7, wherein handling the outliers based on the approximation of the one or more parameters further comprises determining a mean measurement output of a parameter input included in the search space of input parameters.

9. The method of handling outliers of claim 1, wherein the cluster having the maximum consistency value among the clusters is determined to include inliers,
wherein the number of inliers is greater than the number of measurements, and
wherein a number of outliers is greater than a number of inliers.

10. The method of claim 1, wherein the approximated one or more parameters relate to at least one of a position estimate, time synchronization, image processing, video processing, and audio processing.

11. An electronic device comprising:
a processor; and
a non-transitory computer-readable storage medium storing instructions that, when executed, configure the processor to:
determine a set of residuals, wherein each residual represents a difference between a measurement included in a set of measurements and a predetermined estimate;
cluster the residuals into a plurality of clusters;
calculate a consistency value for each of the plurality of clusters based on a number of measurements included in the set of measurements and a standard deviation of the measurements;
identify a cluster having a maximum consistency value among the plurality of clusters as inliers by applying the consistency function to the plurality of clusters; and
handle outliers based on an approximation of one or more parameters as a function of a statistical relationship of the inliers included the cluster having the maximum consistency value among the plurality of clusters and an initial estimation of the one or more parameters.

12. The electronic device of claim 11, wherein, upon executing the instructions, the processor is further configured to select a search stepsize,
wherein clustering the residuals into the plurality of clusters comprises:
clustering a first set of residuals into a first set of the plurality of clusters based on a first stepsize of the search stepsize; and
clustering a second set of residuals into a second set of the plurality of clusters based on a second stepsize of the search stepsize.

13. The electronic device of claim 12, wherein identifying the cluster having the maximum consistency value among the plurality of clusters further comprises:
identifying a first cluster included in the first set of the plurality of clusters as having a first local maximum consistency value;
identifying a second cluster included in the second set of the plurality of clusters as having a second local maximum consistency value; and
determining the maximum consistency value to be a greater value among the first local maximum consistency value and the second local maximum consistency value.

14. The electronic device of claim 13, wherein the approximation of the one or more parameters is based on the statistical relationship of the inliers of the cluster having the global maximum consistency value.

15. The electronic device of claim 12, wherein the first stepsize is a different stepsize than the second stepsize.

16. The electronic device of claim 11, wherein the approximation of the one or more parameters includes an approximation of a set of parameters using the statistical relationship of the inliers included in the cluster having the largest consistency value.

17. The electronic device of claim 11, wherein, upon executing the instructions, the processor is further configured to:
define a search space of input parameters based on an initial parameter and its standard deviation.

18. The electronic device of claim 17, wherein handling the outliers based on the approximation of the one or more parameters further comprises determining a mean measurement output of a parameter input included in the search space of input parameters.

19. The electronic device of claim 11, wherein the cluster having the maximum consistency value among the clusters is determined to include inliers,
wherein the number of inliers is greater than the number of measurements, and
wherein a number of outliers is greater than a number of inliers.

20. The electronic device of claim 11, wherein the approximated one or more parameters relate to at least one of a position estimate, a time synchronization signal, image processing, video processing, and audio processing.
